(19) United States
(12) Patent Application Publication
(10) Pub. No.: US 2006/0061463 A1
(43) Pub. Date: Mar. 23, 2006

(54) Tire pressure monitoring system

(76) Inventor: George A. Wilson II, Belle Vernon, PA (US)

Correspondence Address: BAKER & BOTTS, 30 ROCKEFELLER PLAZA, NEW YORK, NY, 10112, US

(21) Appl. No.: 10/944,550

(22) Filed: Sep. 17, 2004

(51) Int. Cl. B60C 23/00; G01M 17/02; B60C 19/08; G08B 23/00

(52) U.S. Cl. 340/447; 340/693.9; 152/152.1; 73/146

(57) ABSTRACT

A system for monitoring the pressure in a pneumatic tire supported on a wheel of a vehicle, the wheel being rotatable about an axis of rotation and defining a plane of rotation that is perpendicular to the axis of rotation. The system includes a housing mounted on the wheel of the vehicle and a sensor in the housing for measuring a pressure condition in the pneumatic tire. The system also includes a transmitter coupled to the sensor for generating a radio frequency output signal conveying the pressure condition measured by the sensor. The transmitter includes an antenna contained in the housing, where this antenna is configured to transmit the output signal according to a radial pattern. The system further includes an orientation mechanism operative to orient the housing during mounting of the housing to the wheel of the vehicle. The orientation mechanism may be further operative to orient the antenna within the housing. The orientation mechanism ensures that, once the housing is mounted to wheel of the vehicle, the output signal is transmitted substantially in the plane of rotation of the wheel of the vehicle.

### FIELD OF THE INVENTION

The present invention relates generally to the field of pneumatic-tire vehicles. More specifically, the present invention relates to a system for monitoring the pressure in a vehicle tire.

### BACKGROUND OF THE INVENTION

Systems for monitoring the pressure in a tire of a vehicle are well known in the art. Typically, such systems require the mounting of a sensor/transmitter inside the tire of the vehicle, where this sensor/transmitter is a small, electronic device that measures the pressure, and possibly the temperature, in the tire. Most of the commercially available sensor/transmitters are adapted to be either mounted in the drop center of the tire rim or attached internally to the base of the valve stem of the tire.

Unfortunately, many disadvantages arise as a result of mounting the sensor/transmitter inside the tire of the vehicle. Firstly, in order to install, service or remove a sensor/transmitter, the wheel has to be removed from the vehicle and the tire removed from the rim, which usually means that the tire has to be sent to a tire service center. Since the sensor/transmitter needs pressurization to operate, proper operation of the sensor/transmitter can only be confirmed after the tire is remounted on the wheel or, if the tire service center does not have the proper equipment to detect the signal from the sensor/transmitter, after the wheel is remounted on the vehicle. In the worst case scenario, this means that the entire process has to be repeated if the sensor/transmitter is defective. Secondly, sensor/transmitter devices are delicate electronic instruments, easily damaged during installation unless the person performing the installation is specially trained. This requirement is rarely met at tire service centers. Thirdly, lubricants and other contamination usually exist inside a tire and may potentially damage the sensor/transmitter.

In another tire pressure monitoring system, the pressure sensor/transmitter is screwed directly on the tire valve stem, outside of the tire. The sensor/transmitter monitors the tire pressure through the valve stem, where the pressure is the same as inside the tire. Although this solution solves some of the disadvantages discussed above, it creates others. More specifically, the sensor/transmitter assembly adds a cantilevered mass at the tip of the valve stem which, upon rotation of the wheel, creates a high stress on the valve stem. Furthermore, because the orientation of the sensor/transmitter is constantly changing during rotation of the wheel, the transmitted signal is not always received with a consistent strength.

U.S. Pat. No. 4,816,802, issued Mar. 28, 1989 to Ben F. Doerksen, discloses a tire pressure monitoring system for detecting the occurrence of a low pressure condition in any one of a plurality of pneumatic tires of a multi-wheeled vehicle. In this system, a pressure switch is carried by the wheel of each of the monitored tires, mounted in a housing that is attached to the central web of the wheel by a bracket assembly. The housing, a cylindrical structure that is injection molded from plastic, contains an electrical circuit formed of a radio frequency transmitter, a battery and the pressure switch. The pressure switch is in pressure communication with the pneumatic tire through suitable hoses and fittings. When the pressure in the pneumatic tire falls below a predetermined value, the pressure switch closes to close the electrical circuit thereby energizing the transmitter. An indicator of the visual type, such as a light-emitting diode, protrudes from an opening in the wall of the housing so that one can visually determine which of the tires of the vehicle is experiencing a low pressure condition.

Unfortunately, systems such as that described in U.S. Pat. No. 4,816,802 also have weaknesses. Since all of the transmitters broadcast at the same frequency, the indications provided by the cab-mounted receiver/assembly indicate only that one of the tires has a low pressure condition. The driver must get out of the vehicle and walk around to look for the illuminated indicator, in order to determine which of the tires is low. Furthermore, in order to ensure that the radio frequency transmitter operates consistently and reliably at substantially depressed battery voltages, the receiver antenna must be positioned on the vehicle such as to minimize its average distance from the wheel-mounted transmitters, while the transmitter antenna must extend out of the wheel-mounted housing. In the latter case, the portion of the transmitter antenna that protrudes outside of the housing is less protected and thus susceptible to damage, particularly when the vehicle is in motion.

In light of the foregoing, a need clearly exists in the industry for an improved tire pressure monitoring system.

### SUMMARY OF THE INVENTION

As embodied and broadly described herein, the present invention provides a tire pressure monitoring system that overcomes the above-described disadvantages of the prior art systems.

In a first broad aspect, there is provided a system for monitoring the pressure in a pneumatic tire supported on a wheel of a vehicle, the wheel being rotatable about an axis of rotation and defining a plane of rotation that is perpendicular to the axis of rotation. The system includes a housing adapted to be mounted to the wheel of the vehicle, a sensor in the housing for measuring a pressure condition in the pneumatic tire and a transmitter coupled to the sensor for generating a radio frequency output signal conveying the pressure condition measured by the sensor. The transmitter includes an antenna contained in the housing, where this antenna is configured to transmit the output signal according to a radial pattern. The system also includes an orientation mechanism provided at least in part on the housing, operative to orient the housing during mounting of the housing to the wheel of the vehicle, such that the output signal is transmitted substantially in the plane of rotation of the wheel of the vehicle.

The orientation mechanism may be further operative to orient the antenna within the housing.

In a specific, non-limiting example of implementation, the system is implemented on an airport people mover. It should be noted however that the tire pressure monitoring system of the present invention is applicable to any pneumatic-tire vehicle, including monorails, trucks, cars and airplanes, among other possibilities. The tire pressure monitoring system is formed of a plurality of wheel-mounted sensor/transmitter assemblies, in cooperation with one or more receiver assemblies that may be located at various different positions on the vehicle. Each sensor/transmitter assembly is associated with a respective one of the tires of the vehicle.

Each sensor/transmitter assembly is formed of a housing, which is mounted to a respective wheel by a mounting bracket, a pair of mounting clamps and an orientation mechanism. A sensor inside of the housing is connected via an air hose to the valve stem of the pneumatic tire. This sensor is operative for measuring a pressure condition in the associated tire. In addition to the sensor, the housing includes an antenna-based transmitter that is coupled to the sensor for generating and transmitting a radio frequency output signal conveying the information measured by the sensor. The antenna of the transmitter is contained within the housing and is coiled such that it transmits the radio frequency output signal according to a radial pattern.

In this example of implementation, the orientation mechanism takes the form of a pair of fasteners, a pair of openings in the housing and a pair of corresponding openings in the mounting clamps. During mounting of the antenna inside of the housing, the antenna is oriented with respect to the openings in the housing. Furthermore, during mounting of the housing to the wheel, the openings in the housing and in the mounting clamps are aligned in order to receive the fasteners, thereby orienting the housing such that the output signal of the antenna is transmitted in the plane of rotation of the wheel of the vehicle.

In a second broad aspect, there is provided a housing for a tire pressure monitoring system, the system including a sensor for measuring the pressure in a tire supported on a wheel of a vehicle and a transmitter for generating an output signal. The housing is adapted to be mounted to the wheel of the vehicle and includes a hollow body for containing the sensor and transmitter of the tire pressure monitoring system, as well as a pair of end caps, each end cap adapted to be secured to a respective end of the hollow body. One of the end caps is adapted to receive an air hose for attachment to a valve stem of the tire. The other of the end caps is provided with a filler valve via which the pressure of the tire can be adjusted once the housing is assembled and mounted to the wheel of the vehicle.

### BRIEF DESCRIPTION OF THE DRAWINGS

A detailed description of examples of implementation of the present invention is provided hereinbelow with reference to the following drawings, in which:

FIG. 1 is a side view of an airport people mover including a tire pressure monitoring system in accordance with an example of implementation of the present invention;

FIG. 2 is a front view of a wheel assembly of the people mover shown in FIG. 1;

FIGS. 3A and 3B are top planar and side views of a mounting bracket for the tire pressure monitoring system, in accordance with an example of implementation of the present invention;

FIGS. 4A and 4B are side perspective views of a housing for the tire pressure monitoring system, in accordance with an example of implementation of the present invention;

FIG. 5 illustrates an example of sensor/transmitter circuitry suitable for mounting in the housing shown in FIGS. 4A and 4B;

FIG. 6 depicts the transmission pattern of the radio frequency signal broadcast by the transmitter antenna of the wheel-mounted housing, in accordance with an example of implementation of the present invention;

FIG. 7 is a cutaway side view of the housing shown in FIG. 6, once assembled with the sensor/transmitter circuitry and mounted to the wheel of the vehicle; and

FIG. 8 is a flow diagram illustrating an example of operation of the tire pressure monitoring system, in accordance with an example of implementation of the present invention.

In the drawings, embodiments of the invention are illustrated by way of example. It is to be expressly understood that the description and drawings are only for the purposes of illustration and as an aid to understanding, and are not intended to be a definition of the limits of the invention.

### DETAILED DESCRIPTION

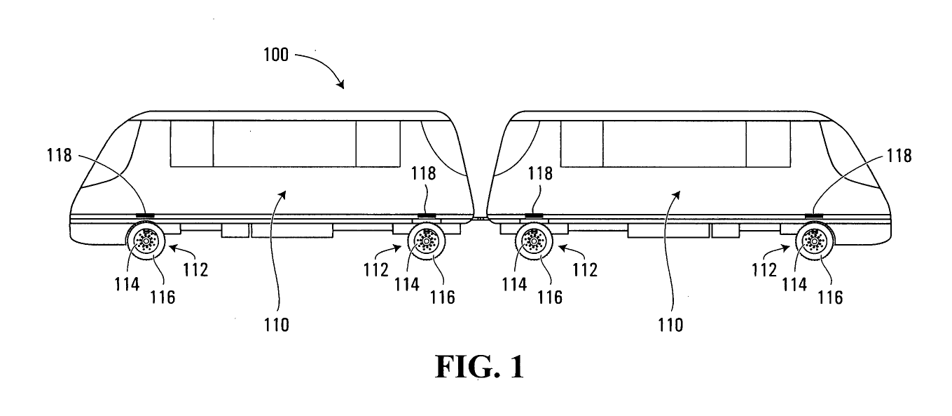

FIG. 1 illustrates a tire pressure monitoring system, in accordance with a specific, non-limiting example of implementation of the present invention.

Note that, in the specific example shown in FIG. 1 and described herein below, the tire pressure monitoring system is implemented on an airport people mover. However, the tire pressure monitoring system of the present invention is applicable to any pneumatic-tire vehicle, including monorails, trucks, cars and airplanes, among other possibilities.

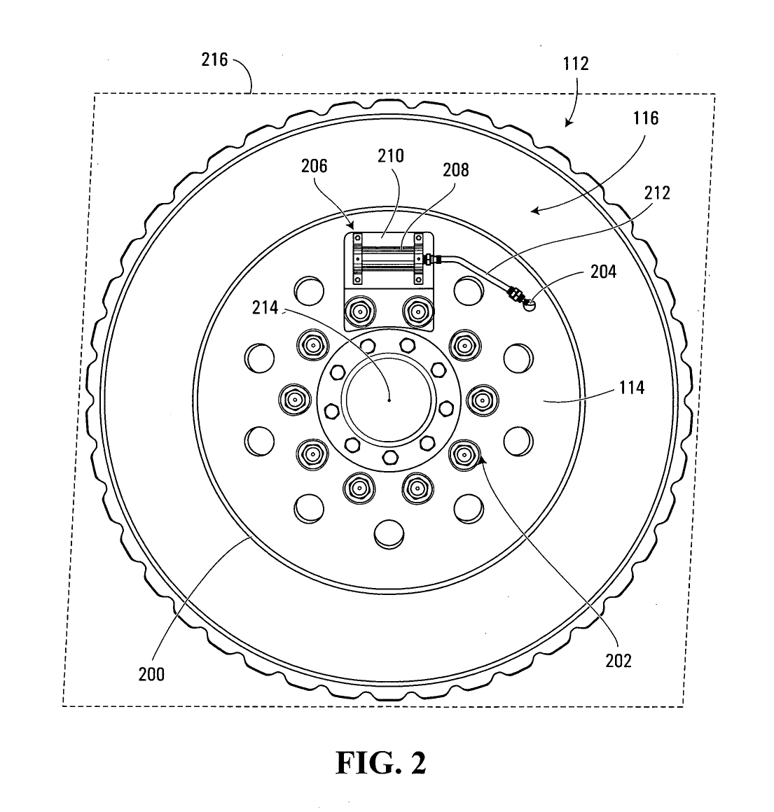

The airport people mover 100 is a multi-wheel vehicle, each car 110 of the vehicle having a pair of front and rear wheel assemblies 112. Each wheel assembly 112 is formed of a wheel 114 with a pneumatic tire 116 supported thereon. As seen in FIG. 2, each wheel 114 is of a conventional design, having an annular tire receiving section 200 and a central plate 202. Various different types of wheel assemblies are conceivable and are included within the scope of the present invention. Each pneumatic tire 116 includes a stem 204 extending through an opening in the wheel 114. Typically, the stem 204 is interiorly threaded to receive a valve (not shown) and also includes an exteriorly threaded section (not shown) which typically receives a cap (not shown) used to prevent dirt or other contaminates from entering the stem 204 and fouling the valve.

With reference to FIG. 2, when the vehicle 100 is in motion, each wheel 114 of the vehicle 100 rotates about a respective axis of rotation 214 and defines a plane of rotation 216 that is perpendicular to its axis of rotation 214.

The airport people mover 100 shown in FIG. 1 is provided with a tire pressure monitoring system. This tire pressure monitoring system is formed of a plurality of wheel-mounted sensor/transmitter assemblies 206, in cooperation with one or more receiver assemblies (not shown) that may be located at various different positions on the vehicle 100. Each sensor/transmitter assembly 206 (seen in FIG. 2) is associated with a respective one of the tires 116 of the vehicle 100.

Each sensor/transmitter assembly 206 is formed of a housing 208 mounted to a respective wheel 114 by a mounting bracket 210, as seen in FIG. 2, where this housing 208 is pressurized and in fluid communication with the pneumatic tire 116. More specifically, the housing 208 is connected via an air hose 212 to the valve stem 204 of the pneumatic tire 116, such that its interior is characterized by the same pressure as that of the tire 116. A sensor (not shown) inside of the housing 208 is operative for measuring a pressure condition inside the housing 208, which is the same as the pressure condition in the associated tire 116. The sensor may also be capable to measure various other parameters, such as temperature and battery voltage, among other possibilities. Alternatively, multiple sensors may be provided inside of the housing 208, for measuring different respective parameters.

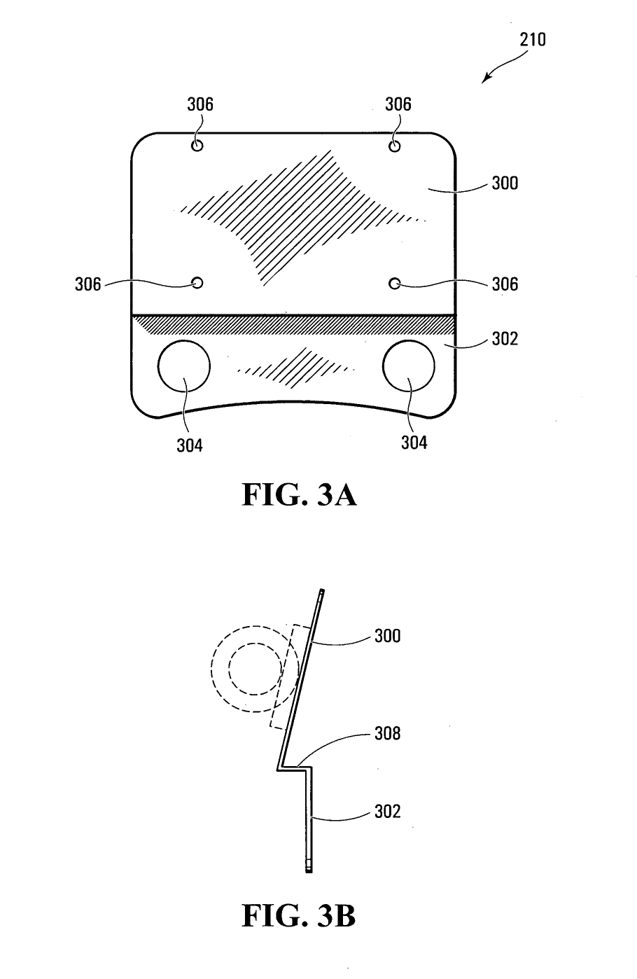

In the non-limiting example shown in FIG. 3A, the mounting bracket 210 includes a first plate portion 300 for receiving the housing 208 and a second plate portion 302 adapted to be attached to two of the mounting studs on which the wheel 114 is bolted. More specifically, the second plate portion 302 has a pair of openings 304 through which respective mounting studs are passed in order to secure the mounting bracket 210 to the wheel 114. The first plate portion 300 itself has four openings 306 for receiving respective threaded fasteners used to secure the housing 208 to the mounting bracket 210, as will be discussed in further detail below.

As seen in the side view of FIG. 3B, an offset 308 separates the first and second plate portions 300, 302. Furthermore, the first plate portion 300 is angled with respect to the second plate portion 302 (as seen in FIG. 3B), in order to account for the rounded surface of the wheel 114. As a result, when mounted to the wheel 114, the second plate portion 302 is substantially flush with the wheel 114, while the first plate portion 300, which carries the housing 208, is suspended above the wheel 114 in alignment with the wheel periphery.

Note that the mounting bracket 210 is made of any suitable material, such as stainless steel.

Although the housing 208 is shown in FIG. 2 as being mounted to the wheel 114 such that the housing 208 is adjacent to the annular tire receiving section 200, the housing 208 could also be mounted in the center of the central plate 202 of the wheel 114. In a specific example, the design of the mounting bracket 210 is adapted such that, once attached to two or more of the mounting studs on which the wheel is bolted, the housing 208 is positioned over the center of the wheel 114.

The housing 208 itself may be of any suitable design and is made of any suitable, lightweight material that is passive to radio frequency transmissions, such as composite or plastic material. In the specific example shown in FIG. 2, the housing 208 is a generally cylindrical canister.

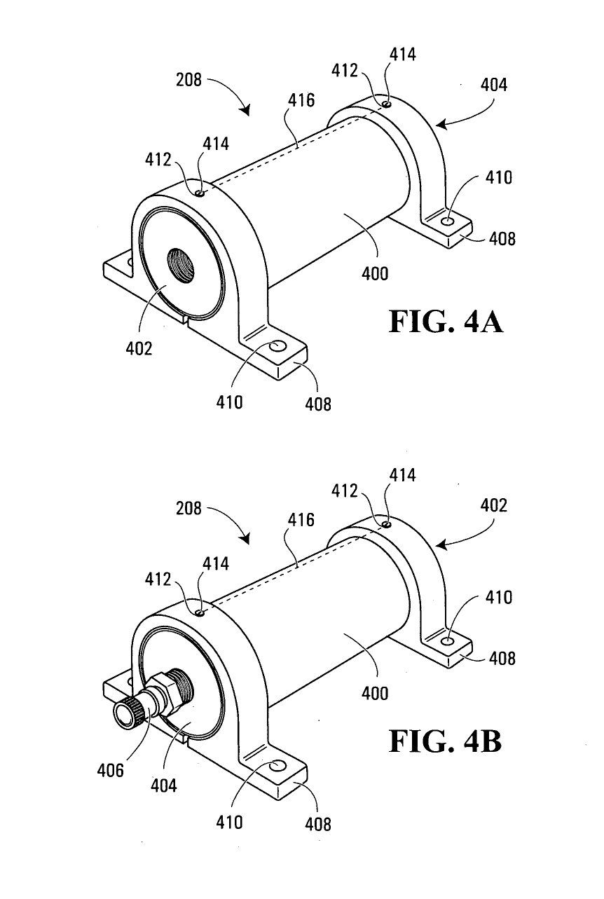

With reference to the example shown in FIGS. 4A and 4B, the housing 208 is formed of a cylindrical body 400 made of composite material, where the fibers are oriented such as to withstand the internal pressure. Alternatively, the cylindrical body 400 could be injection molded from a suitable plastic, for example. The housing 208 also includes a pair of end caps 402, 404 adapted to be secured in any suitable fashion, such as by bonding or by threaded engagement, to respective ends of the cylindrical body 400. Reliability being of high importance, it is preferable that the end caps 402, 404 be bonded to the housing 208, since it is a more effective form of attachment and provides a smaller package than when threaded engagement is used. In the case of a malfunction of the sensor/transmitter located inside of the housing 208, the housing 208 can be dismounted from the wheel 114 and one of the end caps 402, 404 bored out (with the appropriate machinery). The sensor/transmitter may then be repaired or replaced and a new end cap 402, 404 bonded to the housing 208.

One of the end caps 402, 404 (in this example end cap 402) is adapted to engage the air hose 212, for connecting the sensor inside the housing 208 to the tire 116. Optionally, the other of the end caps 402, 404 (in this example end cap 404) may be fitted with a filler valve 406, as will be discussed below.

The air hose 212 constitutes a conduit for transmitting tire pressure from the valve stem 204 of the tire 116 to the interior of the housing 208, and thus to the sensor within the housing 208. In a specific example, each end of the air hose 212 is provided with a fitting, adapted to connect either to end cap 402 of the housing 208 or to the valve stem 204 of the tire 116.

The purpose of the filler valve 406 is to allow the tire 116 to be inflated or deflated in a conventional manner without having to disassemble the wheel-mounted sensor/transmitter assembly 206. More specifically, the filler valve 406 is in fluid communication with the valve stem 204 of the tire 116, via the interior of the housing 208 and the air hose 212. As such, air can be pumped into the tire 116, as well as exhausted out of the tire 116, via the filler valve 406.

The housing 208 is fitted at each end thereof with a pair of mounting clamps 408, which are made of any suitable material, such as nylon or plastic material. Each mounting clamp 408 provides at least one opening 410 for receiving a threaded fastener (as seen in FIG. 2) which, when installed, passes through a corresponding opening 306 in the mounting bracket 210, thereby securing the housing 208 to the mounting bracket 210. Different types of mounting clamps and/or mounting assemblies can be used to mount the housing 208 to the wheel 114 of the vehicle 100, without departing from the scope of the present invention.

The housing 208 is provided with an orientation mechanism, for ensuring that the housing 208 is properly oriented during mounting of the housing 208 to the wheel 114. In the non-limiting example of FIGS. 4A and 4B, each mounting clamp 408 is provided with an opening 412 for receiving a fastener 414, where this fastener 414 is operative to secure the mounting clamp 408 to the housing 208 via a respective opening (not shown) in the body 400 of the housing 208. In a specific example, the fastener 414 is a fiberglass pin that pins the mounting clamp 408 to the body 400 of the housing 208. Advantageously, these openings (not shown) in the body 400 of the housing 208 may be positioned on the body 400 such that, once aligned with the openings 412 of the mounting clamps 408 for receiving the fasteners 414, the housing 208 is characterized by a particular orientation. In other words, the openings (not shown) in the body 400 of the housing 208, as well as the fasteners 414, serve as an orientation mechanism for orienting the housing 208 during mounting of the housing 208 to the wheel 114.

Note that the orientation mechanism may also ensure that the contents of the housing 208 are properly oriented inside of the housing 208, as will be discussed in further detail below.

Furthermore, various different types of orientation mechanisms are possible and may be provided for orienting the housing 208 during mounting to the wheel 114, without departing from the scope of the present invention. In one possible variant example, the orientation mechanism takes the form of markings, such as arrows, inscribed or molded on the housing 208 and mounting clamps 408.

The housing 208 may be of various shapes and sizes, without departing from the scope of the present invention. However, since in use the housing 208 is mounted to a wheel 114 of the vehicle 100, the housing 208 must be sufficiently small and lightweight so as not to disturb the balance of the wheel-tire assembly. In a specific example, the housing 208 is approximately 4 inches in length and 1.5 inches in diameter.

In addition to the sensor, the housing 208 includes a radio frequency transmitter that is tuned to transmit a desired frequency. The transmitter is antenna-based and may be of any suitable type to transmit any suitable frequency. In a specific example, the frequency of the transmitter is 433.95 MHz. The transmitter is coupled to the sensor for generating and transmitting a radio frequency output signal conveying the information measured by the sensor. Preferably, the output signal also conveys a unique identifier of the particular tire 116 from which the information was measured by the sensor. This unique identifier may be numeric or text based, among other possibilities.

The housing 208 may also contain other electronic components, in addition to the sensor and the transmitter, without departing from the scope of the present invention. In a specific example, the housing 208 carries a battery, of any suitable, long-lasting type, for providing power to the sensor/transmitter circuitry.

Advantageously, in the case of a malfunction of the sensor/transmitter circuitry inside the housing 208, the housing 208 may be dismounted from the wheel 114, after which a brand new replacement housing 208 may be mounted to the wheel 114, all within a matter of minutes. This allows the best availability of the vehicle, since it is a lot simpler and quicker to replace a housing 208 than to dismount (and possibly replace) a wheel 114, a procedure that can be quite complicated on some vehicles (such as a monorail). Ideally, a back-up housing is available at all times, for use in replacing a damaged housing 208, which, once repaired, becomes the new back-up housing. Obviously, the cost of maintaining a back-up housing is much less than the cost of maintaining a spare wheel and tire package.

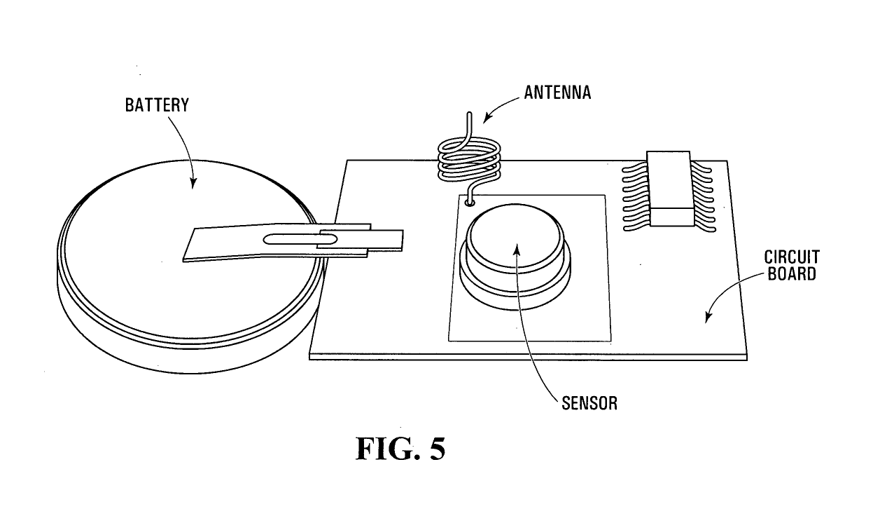

Different types of sensors for measuring pressure, as well as different types of radio frequency transmitters, may be used within the context of the present invention. Furthermore, various different designs of appropriate sensor/transmitter circuitry are commercially available in the market place and may be provided within the housing 208 for performing the above-described operations, without departing from the scope of the present invention. FIG. 5 depicts one example of a printed circuit board designed to provide the above-described sensor/transmitter functionality, where this printed circuit board is designed for installation inside of a housing 208.

Specific to the present invention, the antenna of the transmitter is contained within the housing 208 and is configured to transmit the radio frequency output signal according to a radial, circular pattern.

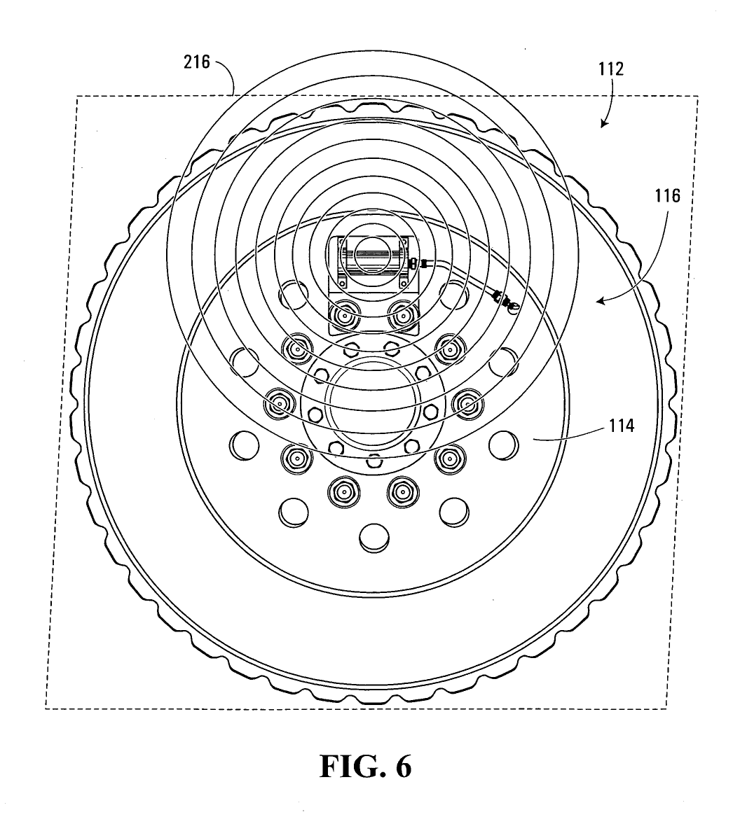

In a non-limiting example of implementation of the present invention, the orientation mechanism described above also provides for positioning of the antenna inside the housing 208. In the specific example shown in FIGS. 4A and 4B, when the antenna is mounted to the housing 208, the antenna is positioned on the basis of the openings in the body 400 of the housing 208 that are intended to receive the fasteners 414. More specifically, the antenna is positioned such that it is aligned with a straight reference line drawn between the openings in the body 400 (see corresponding reference line 416 in FIGS. 4A and 4B). Thus, the orientation mechanism provided by these openings in the body 400 serves not only to orient the housing 208 on the wheel 114 during mounting of the housing 208 to the wheel 114, but also to orient the antenna within the housing 208. As a result of the specific orientation of the antenna within the housing 208 and of the housing 208 on the wheel 114, the antenna transmits its output signal in the plane of rotation of the respective wheel 114 of the vehicle 100, as shown in FIG. 6.

Note that other electronic components contained within the housing 208, such as the sensor, may also be oriented inside of the housing 208 on the basis of the orientation mechanism, which in this example is provided in part by the openings in the body 400 that are intended to receive the fasteners 414.

Alternatively, the antenna and other electronic components may be positioned inside of the housing 208 without relying on the orientation mechanism. In this case, the openings in the body 400 shown in FIGS. 4A and 4B would be made after all components had been installed inside of the housing 208. However, the openings would be positioned on the body 400 of the housing 208 such as to ensure proper orientation of the antenna once the housing is mounted to the wheel 114 of the vehicle 100.

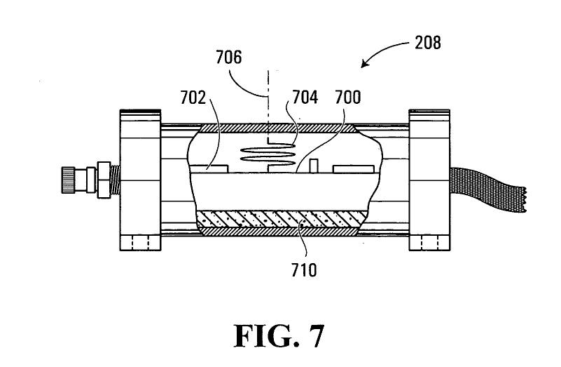

FIG. 7 is a cross-sectional side view of housing 208, once assembled with the sensor/transmitter circuitry, according to an example of implementation of the present invention. Inside the housing 208 is a printed circuit board 700 with the sensor/transmitter circuitry and a battery 702. It should be noted that additional circuitry and/or electronic devices may also be installed inside of the housing 208 without departing from the scope of the present invention.

The circuit board 700 is mounted inside the housing 208 by means of a resilient, binding material 710, such as silicone, that is capable to absorb shocks and stabilize the circuit board 700 within the housing 208.

The antenna 704 of the transmitter is coiled and oriented within the housing 208 to define a central axis 706. Due to the electromagnetic properties of a coiled antenna, the output signal transmitted by the antenna 704 is characterized by circular polarization. Once the housing 208 is mounted to a wheel 114 of the vehicle 100, the coiled antenna 704 is positioned such that its central axis 706 is parallel to the axis of rotation 214 of the wheel 114. The coiled antenna 704 will therefore transmit its output signal in the same plane as the plane of rotation 216 of the wheel 114. The electromagnetic properties of a coiled antenna are well known to those skilled in the art and, as such, will not be discussed further herein.

Note that the coiled antenna 704 may be characterized by any number of loops, without departing from the scope of the present invention.

As discussed above, the position of the openings in the body 400 of the housing that are intended to receive the fasteners 414, as well as the fasteners 414 themselves, ensure that the coiled antenna 704 is characterized by a particular orientation once mounted to the wheel 114. More specifically, during mounting of the housing 208 to the wheel 114, the forced alignment between the openings in the body 400 and the openings 412 in the mounting clamps 408, as well as the maintenance of this alignment by the fasteners 414, ensures that the coiled antenna 704 is properly oriented to radiate its output signal in a particular direction. In a specific example, this particular direction is in the same plane as the plane of rotation 216 of the wheel 114.

Advantageously, the antenna of the transmitter is protected from the elements since it is completely enclosed within the housing 208.

In a specific example, once unwound, the length of the antenna 704 is ¼ the wavelength of the radio frequency output signal transmitted by the transmitter. Since wavelength (λ) can be calculated from frequency (ν) by a known formula [λ(in feet)=984/ν(in Mhz)], it can be determined that for a transmitter frequency of 433.95 MHz, the wavelength is approximately 2.27 feet long. It then follows that the length of the antenna 704 is just over ½ foot, or approximately 6.84 inches. Note that antenna lengths of different fractions of the wavelength of the radio frequency output signal are possible and can be used within the tire pressure monitoring system without departing from the scope of the present invention.

As mentioned above, the tire pressure monitoring system also includes at least one receiver assembly, which may be located at various different positions on the vehicle 100. This receiver assembly includes a receiver antenna oriented and tuned to receive the radio frequency output signals broadcast by the transmitter antennas of the plurality of sensor/transmitter assemblies 206.

In a specific, non-limiting example of implementation, the tire pressure monitoring system of the airport people mover 100 includes a plurality of receiver assemblies. With reference to FIG. 1, each receiver assembly is formed of a receiver sub-unit (not shown) mounted inside the vehicle 100 as well as an associated receiver antenna 118 connected to the receiver unit. Each receiver antenna 118 is mounted to the frame of the vehicle 100 in proximity to a respective one of the sensor/transmitter assemblies 206. As shown in FIG. 1, the receiver antennas 118 are oriented such that they run parallel to the longitudinal axis of the vehicle 100. Alternatively, the receiver antennas 118 may be oriented such that they run transversely to the longitudinal axis of the vehicle 100, an orientation well-suited to receiving the radio frequency output signals broadcast by the transmitter antenna of the respective sensor/transmitter assembly 206. Various different orientations of the receiver antennas 118 on the frame of the vehicle 100 are possible and are included within the scope of the present invention.

Note that the use of a plurality of receiver assemblies provides redundancy, and thus reliability, to the tire pressure monitoring system. However, the provision of a single receiver assembly on the airport people mover 100 would suffice to ensure the functionality of the tire pressure monitoring system. In a specific example, the receiver antenna 118 of the single receiver assembly would be oriented such that it runs transversely to the longitudinal axis of the vehicle 100.

Taken together, the plurality of receiver sub-units form a receiver unit that is in communication with an operator of the vehicle 100. This receiver unit is responsive to the output signals received from the various sensor/transmitter assemblies 206 to cause a first predefined alarm message to be transmitted to an operator of the vehicle 100 if a low pressure condition is detected in one of the tires 116 of the vehicle 100. The receiver unit will cause a second predefined alarm message to be transmitted to the operator of the vehicle 100 if one of the sensor/transmitter assemblies 206 seems to be malfunctioning. Each of these predefined alarm messages may take the form of a visual indicator, such as a blinking light on the control panel of the vehicle 100 or a text message on a display. Alternatively, the predefined alarm message may take the form of an audible alarm, among other possibilities.

Preferably, the alarm message provided to the operator of the vehicle 100 includes an indication of the particular tire 116 in which a low pressure condition has been detected or of the particular sensor/transmitter assembly 206 that is malfunctioning.

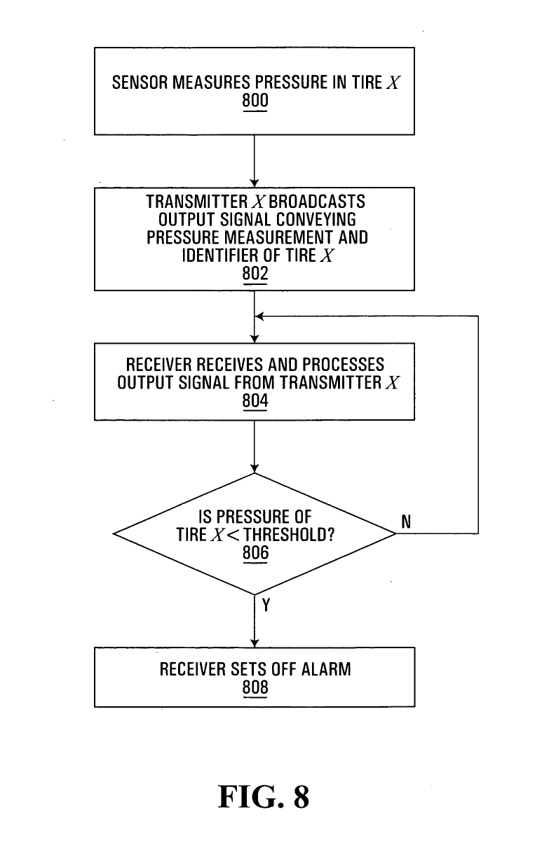

FIG. 8 is a flow diagram illustrating an example of operation of the tire pressure monitoring system, according to an example of implementation of the present invention. At step 800, the sensor X of sensor/transmitter assembly X measures the pressure in the corresponding tire X. Note that this measurement operation by the sensor X takes place at regular intervals, for example every 3 to 5 minutes. At step 802, the associated transmitter X generates and broadcasts via its antenna an output signal conveying the pressure measurement taken by sensor X, as well as the identifier of the respective tire X, at a predetermined radio frequency. At step 804, the receiver unit receives the output signal from transmitter X and processes the pressure measurement of the tire X. If the pressure of the tire X is below a predefined threshold at step 806, the receiver unit sets off an alarm in the cab of the vehicle at step 808, in order to bring the low pressure condition of tire X to the attention of an operator of the vehicle.

Note that, since the sensor X takes pressure measurements at regular intervals, the receiver unit should receive output signals from the transmitter X at regular intervals. In a variant, the receiver unit is capable to monitor the arrival of output signals from transmitter X. If the receiver unit has not received an output signal from transmitter X for over a predetermined amount of time, for example 15 minutes, the receiver unit may set off an alarm to advise the operator of the vehicle that the sensor/transmitter assembly X is malfunctioning.

In another variant, the sensor is capable to adjust the interval at which pressure measurements are taken on the basis of the variation between subsequent pressure measurements. Thus, if the pressure variation between sequential pressure measurements is more than a certain value, for example 3 psi per minute, the sensor is operative to take pressure measurements, and the transmitter is operative to broadcast these same measurements, more frequently.

Although various embodiments have been illustrated, this was for the purpose of describing, but not limiting, the invention. Various modifications will become apparent to those skilled in the art and are within the scope of this invention, which is defined more particularly by the attached claims.

1. A system for monitoring the pressure in a pneumatic tire supported on a wheel of a vehicle, the wheel being rotatable about an axis of rotation and defining a plane of rotation that is perpendicular to the axis of rotation, said system comprising:
a housing adapted to be mounted to the wheel of the vehicle;
a sensor in said housing for measuring a pressure condition in the pneumatic tire;
a transmitter coupled to said sensor for generating a radio frequency output signal conveying the pressure condition measured by said sensor, said transmitter including an antenna contained in said housing, said antenna configured to transmit said output signal according to a radial pattern;
an orientation mechanism provided at least in part on said housing, said orientation mechanism operative to orient said housing during mounting of the housing to the wheel of the vehicle, such that said output signal is transmitted substantially in the plane of rotation of the wheel of the vehicle.

2. A system as defined in claim 1, wherein said orientation mechanism is further operative to orient said antenna within said housing.

3. A system as defined in claim 2, wherein said orientation mechanism ensures that said antenna is positioned within said housing such that, when said housing is mounted to the wheel of the vehicle, said antenna defines a longitudinal axis that is substantially parallel to the axis of rotation of the wheel.

4. A system as defined in claim 3, wherein said antenna is coiled.

5. A system as defined in claim 4, wherein said output signal is characterized by a wavelength, the length of said antenna being ¼ the wavelength of said output signal.

6. A system as defined in claim 4, wherein said output signal is characterized by a frequency of 433.95 MHz.

7. A system as defined in claim 1, wherein said output signal includes an identifier of the tire being monitored by said sensor.

8. A system as defined in claim 7, wherein said identifier is numerical.

9. A system as defined in claim 7, wherein said identifier is textual.

10. A system as defined in claim 1, further comprising a receiver unit adapted to be mounted on the vehicle for receiving said output signal from said transmitter, said receiver unit operative to monitor said output signal for detecting a low pressure condition in the tire of the vehicle.

11. A system as defined in claim 10, wherein said receiver unit includes a receiver antenna tuned to the frequency of said transmitter.

12. A system as defined in claim 11, wherein, when said receiver unit is mounted on the vehicle, said receiving antenna is characterized by an orientation that is substantially parallel to the axis of rotation of the wheel.

13. A system as defined in claim 11, wherein, when said receiver unit is mounted on the vehicle, said receiver unit is positioned on the vehicle such that said receiving antenna is located within the plane of rotation of the wheel.

14. A system as defined in claim 10, wherein said receiver unit is operative to transmit an alarm message to a driver of the vehicle in response to the detection of said low pressure condition in the tire.

15. A system as defined in claim 14, wherein said alarm message includes an indication of the particular tire in which said low pressure condition has been detected.

16. A system as defined in claim 10, wherein said receiver unit is operative to transmit an alarm message to a driver of the vehicle in response to the failure of said transmitter to transmit said output signal to said receiver unit within a predetermined delay.

17. A system as defined in claim 1, wherein said sensor is further operative to measure a temperature condition in the pneumatic tire, said output signal conveying the pressure and temperature conditions measured by said sensor.

18. A system as defined in claim 1, wherein said housing further contains a power source, said sensor being further operative to measure a voltage of said power source, said output signal conveying the pressure condition and voltage measured by said sensor.

19. A system as defined in claim 1, wherein said housing is made of a material that is passive to radio frequency transmissions.

20. A system as defined in claim 19, wherein said housing is made of composite material.

21. A system as defined in claim 19, wherein said housing is made of plastic material.

22. A system as defined in claim 1, wherein said housing includes:
a cylindrical body; and
a pair of end caps, each end cap being secured to a respective end of said cylindrical body.

23. A system as defined in claim 22, wherein said housing further includes a pair of mounting clamps, each mounting clamp adapted to detachably mount a respective end of said housing to the wheel of the pneumatic tire.

24. A system as defined in claim 22, wherein one of said end caps is adapted to receive an air hose for attachment to a valve stem of the pneumatic tire.

25. A system as defined in claim 24, wherein the other of said end caps is provided with a filler valve via which the pressure of the pneumatic tire can be adjusted.

26. A system as defined in claim 22, wherein each of said end caps is bonded to the respective end of said cylindrical body.

27. A system as defined in claim 22, wherein said orientation mechanism includes a pair of spaced-apart openings in said cylindrical body.

28. A system as defined in claim 23, wherein said orientation mechanism includes:
a first pair of spaced-apart openings in said cylindrical body;
a second pair of openings, each one of said second pair of openings being provided in a respective one of said mounting clamps; and
a pair of fasteners, each fastener adapted to engage a respective one of said first pair of openings and a corresponding one of said second pair of openings when said housing is mounted to the wheel of the vehicle.

29. The use of the system defined in claim 1 on a pneumatic-tire vehicle selected from the group consisting of: monorail, people mover, truck, tractor-trailer, bus, automobile and airplane.

30. In combination:
a vehicle comprising a plurality of wheels supporting respective pneumatic tires, each wheel being rotatable about an axis of rotation and defining a plane of rotation that is perpendicular to the respective axis of rotation;
a tire pressure monitoring system comprising:
a) a plurality of housings, each housing mounted to a respective wheel of said vehicle and containing:
i) a sensor for measuring a pressure condition in the respective pneumatic tire;
ii) a transmitter coupled to said sensor for generating a radio frequency output signal conveying the pressure condition measured by said sensor, said transmitter including an antenna configured to transmit said output signal according to a radial pattern;
iii) a plurality of orientation mechanisms, each orientation mechanism provided at least in part on a respective one of said plurality of housings for orienting said housing during mounting of said housing to the respective wheel of the vehicle, such that said output signal generated by said transmitter contained in said housing is transmitted substantially in the plane of rotation of the respective wheel of the vehicle;
b) at least one receiver mounted to the vehicle for receiving said output signals from said plurality of housings, said at least one receiver operative to monitor said output signals for detecting a low pressure condition in one of the tires of the vehicle.

31. A housing for a tire pressure monitoring system, the system including a sensor for measuring the pressure in a tire supported on a wheel of a vehicle and a transmitter for generating an output signal, said housing adapted to be mounted to the wheel of the vehicle and comprising:
a hollow body for containing the sensor and transmitter of the tire pressure monitoring system;
a pair of end caps, each end cap adapted to be secured to a respective end of said hollow body, one of said end caps adapted to receive an air hose for attachment to a valve stem of the tire, the other of said end caps being provided with a filler valve via which the pressure of the tire can be adjusted once said housing is assembled and mounted to the wheel of the vehicle.

32. A housing as defined in claim 31, further comprising an orientation mechanism for orienting the antenna within said housing.

33. A housing as defined in claim 31, further comprising at least one mounting clamp for detachably mounting said housing to the wheel of the vehicle.

34. A housing as defined in claim 31, further comprising a pair of mounting clamps, each mounting clamp adapted to detachably mount a respective end of said housing to the wheel of the vehicle.

35. A housing as defined in claim 31, wherein said end caps are bonded to the respective ends of said hollow body.

36. A housing as defined in claim 31, wherein said housing is a canister.

37. A housing as defined in claim 31, wherein said housing is made of a material that is passive to radio frequency transmissions.
